(19) United States
(12) Patent Application Publication
(10) Pub. No.: US 2016/0286173 A1
(43) Pub. Date: Sep. 29, 2016

(54) INDOOR MONITORING SYSTEM AND METHOD THEREOF

(71) Applicant: Apacer Technology Inc., New Taipei City (TW)

(72) Inventor: YI-HSIUNG WANG, New Taipei City (TW)

(21) Appl. No.: 14/844,814

(22) Filed: Sep. 3, 2015

(30) Foreign Application Priority Data
Mar. 25, 2015 (TW) 104109479

(51) Int. Cl. H04N 7/18; G05D 1/08; G06K 9/00; B60R 1/00; G06K 9/62; G05D 1/00; B64C 39/02

(52) U.S. Cl. CPC H04N 7/185; G05D 1/0088; G05D 1/0808; B64C 39/024; B60R 1/00; G06K 9/6215; G06K 9/00201; B64C 2201/141; B64C 2201/123; B60R 2300/80

(57) ABSTRACT

An indoor monitoring system and a method thereof are provided. The system includes an aircraft body; an image capturing unit capturing multiple images in an indoor space in an order of a capturing sequence; a storage unit storing a 3D indoor map corresponding to the indoor space, where the 3D indoor map includes multiple default images and a default flying path; a positioning unit generating 3D space information of the aircraft body; a transmitting unit receiving a control instruction or transmit each image; a processing unit driving the aircraft body to fly in the indoor space according to the default flying path and comparing a default image with an image in pairs in the order of the capturing sequence. The position of the aircraft body on the default flying path can be corrected by the comparing result and the goal of monitoring the indoor space can be achieved.

### CROSS-REFERENCE TO RELATED APPLICATION

This application claims priority from Taiwan Patent Application No. 104109479, filed on Mar. 25, 2015, in the Taiwan Intellectual Property Office, the content of which are hereby incorporated by reference in their entirety for all purposes.

### BACKGROUND OF THE INVENTION

1. Field of the Invention

This application relates to an indoor monitoring system and a method thereof, and more particularly, to an indoor monitoring system and a method thereof applying a micro aircraft to perform monitoring.

2. Description of the Related Art

In view of the technique of the micro aerial vehicle (MAV), such as the quadcopter, has become mature, more and more applications, such as aerial photography, extreme sports, self-timer, and so on are gradually derived therefrom. The main feature lies in that the captured image has a larger visible range and the angle of shot is different from that taken by people through cameras. Thus, it is gradually adored by the masses. However, most applications are only feasible to be used in an outdoor space, the reason is that the range of motion of the MAV is subject to the indoor space and the MAV per se is prone to be damaged by accidental collision.

In another aspect, the conventional indoor monitoring systems, which are mainly assembled with multiple monitors to perform monitoring, apply the images captured by each monitor to perform monitoring in the specific indoor space. However, such monitoring system may have defect of blind spot. In other words, the monitors are unable to capture all the images in the space thoroughly, and the installation and maintenance of the monitor are costly.

Therefore, the foregoing technical problems may be resolved provided that the function of image capturing of the quadcopter can be effectively combined with the indoor monitoring system.

### SUMMARY OF THE INVENTION

In view of the foregoing technical problems, the present invention aims to resolve the shortcomings of the blind spot of the conventional indoor monitoring system.

In view of the foregoing technical problem, an indoor monitoring system and a method thereof derived from the quadcopter are applied to perform monitoring in an indoor space and the used aircraft is free from being damaged by the accidental collision in the indoor space.

In accordance with the aforementioned objective, the present invention provides an indoor monitoring method which is applicable to control a micro aircraft in an indoor space. The micro aircraft includes an aircraft body, an image capturing unit, a storage unit, a positioning unit, a processing unit, a transmitting unit and a power supply unit. The indoor monitoring method includes following steps: reading a 3D indoor map stored in the storage unit, wherein the 3D indoor map includes multiple default images and each default image includes at least one target; driving the aircraft body to fly in the indoor space according to a default flying path of the indoor map; capturing multiple images in the indoor space in an order of a capturing sequence by the image capturing unit, wherein each captured image includes at least one feature point; comparing each default image with each captured image in pairs in the order of the capturing sequence; and calculating an offset distance between the aircraft body and the at least one feature point and correcting a position of the aircraft body on the default flying path according to the offset distance when the at least one target of the default image in each pair matches the at least one feature point of the captured image, wherein the processing unit applies 3D space information generated by the positioning unit to further correct the position of the aircraft body on the default flying path.

Preferably, the indoor monitoring method disclosed in the present invention may further include transmitting the captured image to a cloud server by the transmitting unit and the cloud server performing image recognition to the captured image when the at least one target of the default image in each pair does not match the at least one feature point of the captured image.

Preferably, the indoor monitoring method disclosed in the present invention may further include disposing a wireless charging unit in a landing pad, and the wireless charging unit may charge the power supply unit when the aircraft body lands on the landing pad.

Preferably, the indoor monitoring method disclosed in the present invention may further include receiving a control instruction by the transmitting unit and driving the aircraft body according to the control instruction by the processing unit.

Preferably, the indoor monitoring method disclosed in the present invention may further include driving the aircraft body to perform monitoring in a specific time or place according to the control instruction.

Preferably, the positioning unit may include a triaxial accelerometer, a gyroscope, an electronic compass, or a combination thereof.

Preferably, the indoor monitoring method disclosed in the present invention may further include instantly transmitting each captured image to a mobile device by the transmitting unit.

Preferably, the aircraft body may further include a smoke detector, a CO₂ detector, a light source detector, a motion detector, or a combination thereof.

According to aforementioned objectives, the present invention further provides an indoor monitoring system which includes an aircraft body, an image capturing unit, a storage unit, a positioning unit, a transmitting unit and a processing unit. The image capturing unit captures multiple images in an indoor space in an order of a capturing sequence, wherein each captured image includes at least one feature point. The storage unit stores a 3D indoor map corresponding to the indoor space, wherein the 3D indoor map includes multiple default images and a default flying path, and each default image includes at least one target. The positioning unit generates 3D space information of the aircraft body. The transmitting unit receives a control instruction or transmits each captured image. The processing unit is electrically connected to the aircraft body, the image capturing unit, the storage unit, the positioning unit, and the transmitting unit. The processing unit drives the aircraft body to fly in the indoor space according to the default flying path and compare each default image with each captured image in pairs in the order of the capturing sequence, and calculates an offset distance between the aircraft body and each feature point and corrects a position of the aircraft body on the default flying path according to the offset distance when the at least one target of the default image matches the at least one feature point of the captured image in each pair. The image capturing unit, the storage unit, the positioning unit, the transmitting unit and the processing unit may be disposed on the aircraft body. The processing unit applies 3D space information generated by the positioning unit to further correct the position of the aircraft body on the default flying path.

Preferably, the transmitting unit may transmit the captured image to a cloud server and the cloud server performs image recognition to the captured image when the at least one target of the default image does not match the at least one feature point of the captured image in each pair.

Preferably, the image capturing unit, the storage unit, the positioning unit, the transmitting unit and the processing unit may be disposed on the aircraft body.

Preferably, the indoor monitoring system may further include a power supply unit and a wireless charging unit. The power supply unit is disposed on the aircraft body for supplying power thereto, and the wireless charging unit is disposed on a landing pad for charging the power supply unit when the aircraft body lands on the landing pad.

Preferably, the processing unit may drive the aircraft body to perform monitoring in a specific time or place according to the control instruction.

Preferably, the indoor monitoring system may further include a driving unit and a robotic manipulator. The driving unit is disposed on the aircraft body and electrically connected to the robotic manipulator and the processing unit controls the driving unit to drive the robotic manipulator to move according to the control instruction.

Preferably, the positioning unit may include a triaxial accelerometer, a gyroscope, an electronic compass, or a combination thereof.

Preferably, the transmitting unit may instantly transmit each captured image to a mobile device.

Preferably, the aircraft body may further include a smoke detector, a CO₂ detector, a light source detector, a motion detector, or a combination thereof.

### BRIEF DESCRIPTION OF THE DRAWINGS

Hereinafter, embodiments of the present invention will be described in detail with reference to the accompanying drawings so that those skilled in the art to which the present invention pertains can realize the present invention, in which:

FIG. 1 is a block diagram of an embodiment of an indoor monitoring system according to the present invention.

FIG. 2A is the first schematic diagram of another embodiment of an indoor monitoring system according to the present invention.

FIG. 2B is the second schematic diagram of another embodiment of an indoor monitoring system according to the present invention.

FIG. 3 is a schematic diagram of the second embodiment of an indoor monitoring system according to the present invention.

FIG. 4 is a schematic diagram of the third embodiment of an indoor monitoring system according to the present invention.

FIG. 5 is a flow chart of an embodiment of an indoor monitoring method according to the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

The exemplary embodiments of the present invention will be understood more fully from the detailed description given below and from the accompanying drawings of various embodiments of the invention, which, however, should not be taken to limit the invention to the specific embodiments, but are for explanation and understanding only.

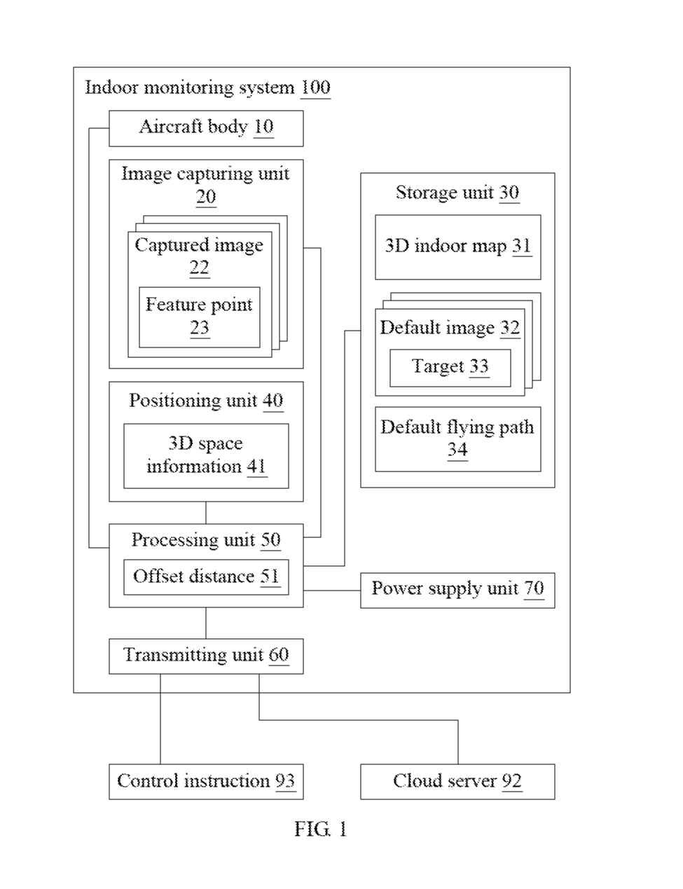

Please refer to FIG. 1, which is a block diagram of an embodiment of an indoor monitoring system according to the present invention. As shown in FIG. 1, an indoor monitoring system 100 includes an aircraft body 10, an image capturing unit 20, a storage unit 30, a positioning unit 40, a processing unit 50, a transmitting unit 60 and a power supply unit 70. In the present embodiment, the image capturing unit 20, the storage unit 30, the positioning unit 40, the processing unit 50 and the transmitting unit 60 are disposed on the aircraft body 10, but it shall be not limited thereto. The storage unit 30 and the processing unit 50 may be disposed outside the aircraft body 10.

The aircraft body 10 may be an unmanned aerial vehicle. The image capturing unit 20 may be a lens module. The storage unit 30 may be a physical memory. The positioning unit 40 may include a triaxial accelerometer, a gyroscope, an electronic compass, or a combination thereof. The processing unit 50 may be a microprocessor. The transmitting unit 60 may be a networking chip module. The power supply unit 70 may be a chargeable and dischargeable battery which is applied to provide the aircraft body 10 with the necessary power.

The image capturing unit 20 captures multiple images 22 in an indoor space in an order of a capturing sequence, and the indoor space may be a factory or a market. Each of the multiple images 22 includes at least one feature point. The storage unit 30 stores a 3D indoor map 31 corresponding to the indoor space. The 3D indoor map 31 includes the multiple default images 32 and a default flying path 34 and each of the default images 32 includes at least one target.

It is worth mentioning that the mentioned default flying path 34 may be arranged by the user. The user may decide a flying path in the indoor space in advance, and the aircraft body 10 is driven to perform the first flight according to the flying path; meanwhile, the processing unit 50 reads the 3D indoor map 31, which only includes the multiple default images 32 at this moment, stored in the storage unit 30. The processing unit 50 may add a default flying path 34 in the 3D indoor map 31 according to information obtained from the first flight. The information, which may include the images captured by the image capturing unit 20 in the indoor space during the first flight, is used to compare with the default images 32 to obtain the positions where the aircraft body 10 flies in the indoor space. Afterwards, those positions are combined to obtain the default flying path 34, and the default flying path 34 is stored in the storage unit 30.

The positioning unit 40 is applied to generate the 3D space information 41 obtained from the flight of the aircraft body 10. The generated 3D space information 41 is mainly applied to measure the offset angle on X-axis, Y-axis and Z-axis of the default flying path 34 when the aircraft body 10 is flying according to the default flying path 34. The transmitting unit 60 is applied to receive a control instruction 93 or transmit each captured image 22. The control instruction 60 may be sent through the internet by an electronic device, such as a cell, a tablet, or a computer. The processing unit 50 is electrically connected to the aircraft body 10, the image capturing unit 20, the storage unit 30, the positioning unit 40 and the transmitting unit 60. The processing unit 50 drives the aircraft body 10 to fly in the indoor space 91 according to the default flying path 34, and compares each default image 32 and each captured image 22 in pairs according to the order of the capturing sequence.

To be precise, each captured image 22 corresponds to each default image 32 in the order of the capturing sequence, and more preferably, each feature point 23 of the captured image 22 matches each target 33 of the default image 32. It means that the captured image is as expected and no unusual situation occurs when the match is completely satisfied. In addition, 2 or 3 lenses may be disposed around the aircraft body 10 to cover a 360-degree view angle, and the shortcomings of blind spot in image capture may be hereby avoided.

Moreover, an offset distance 51 between the aircraft body 10 and each feature point 23 may be calculated and a position of the aircraft body 10 on the default flying path 34 may be corrected according to the offset distance 51 when each target 33 of the default image 32 matches each feature point 23 of the captured image 22 in each pair. Besides, the processing unit 50 may apply the 3D space information 41 generated by the positioning unit 40 to further correct the position of the aircraft body 10 on the default flying path 34.

For example, the aircraft body 10 flies to a position where the ideal distances between the default flying path 34 and two feature points 23 are respectively 1 m and 1.5 m, but the practical distances between the aircraft body 10 at the position and the two feature points 23 are respectively 0.7 m and 1.2 m due to the flight errors. It can be found that the offset distance 51 between the aircraft body 10 and the two feature points are respectively 0.3 m and 0.3 m. Thus, the processing unit 50 corrects the position of the aircraft body 10 on the default flying path 34 according to the information. In addition, the 3D space information 41 generated by the positioning unit 40 can be applied to correct the inclined angle of the aircraft body 10, such that the aircraft body 10 continues to correctly fly in the default flying path 34 without hitting the other objects and getting damaged owing to the deviation from the default flying path 34.

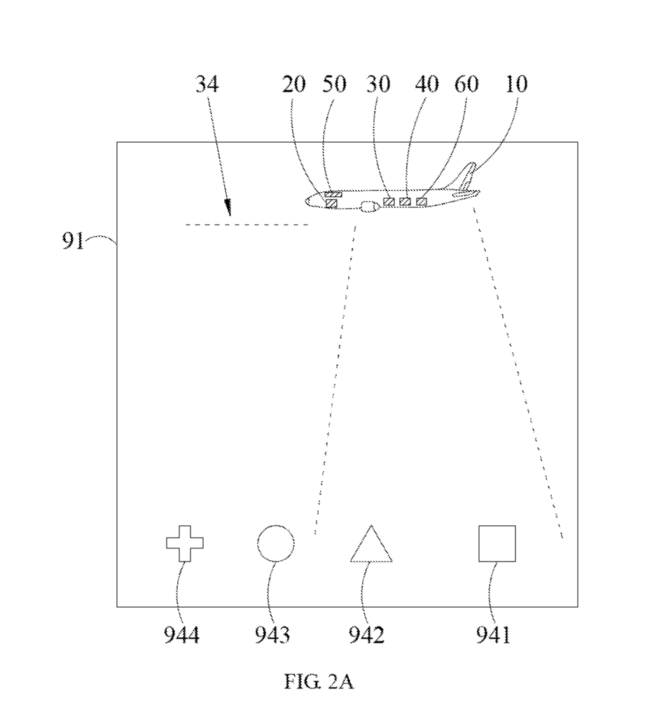

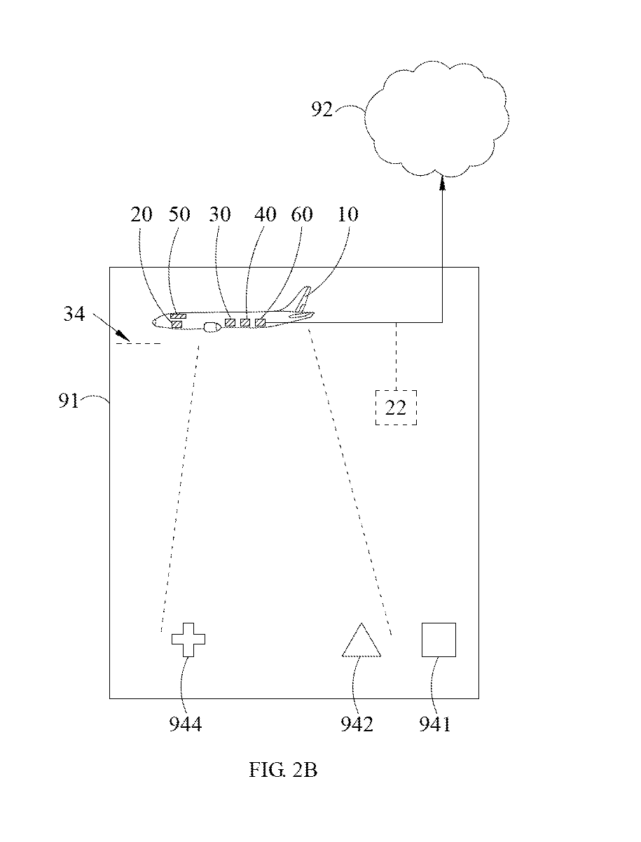

Please refer to FIG. 2A and FIG. 2B which are respectively the first and the second schematic diagrams of another embodiment of an indoor monitoring system according to the present invention. Here, please refer to FIG. 1, FIG. 2A and FIG. 2B together. It is worth mentioning that the storage unit 30 stores two default images 32 in the present embodiment. The first default image 32 includes targets corresponding to the objects 941 and 942, and the second default image 32 includes targets corresponding to the objects 942, 943, and 944. As shown in FIG. 2A, when the aircraft body 10 flies in the indoor space 91 according to the default flying path 34, the image capturing unit 20 captures the image 22 comprising the objects 941, 942, and the processing unit 50 compares the captured image 22 with the first default image 32 stored in the storage unit 30. As shown in FIG. 2B, when the match is satisfied, the aircraft body 10 flies to next position according to the default flying path 34.

In next position, the captured image 22 only includes objects 942 and 944.After the second default image 32 including the target 33 is compared with the captured image 22, since they do not completely match each other, the transmitting unit 60 transmits the captured image 22 to a cloud server 92, and the cloud server 92 performs the image recognition to the captured image 22 with a high computation complexity to obtain the content of the captured image 22.

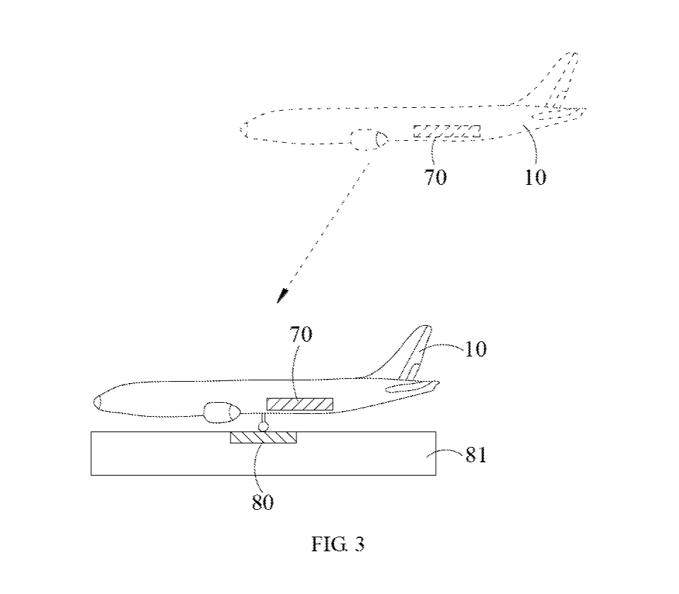

Please refer to FIG. 3 which is a schematic diagram of the second embodiment of an indoor monitoring system according to the present invention. Here, please refer to FIG. 1 and FIG. 3 together. The indoor monitoring system 100 according to the present invention may further include the wireless charging unit 80 disposed on the aircraft body 10 for supplying power to the power supply unit 70. The wireless charging unit 80 is disposed on a landing pad 81 for charging the power supply unit 70 when the aircraft body 10 lands on the landing pad 81. The landing pad may be the start point or the end point of the flight, or any position of the default flying path 34.

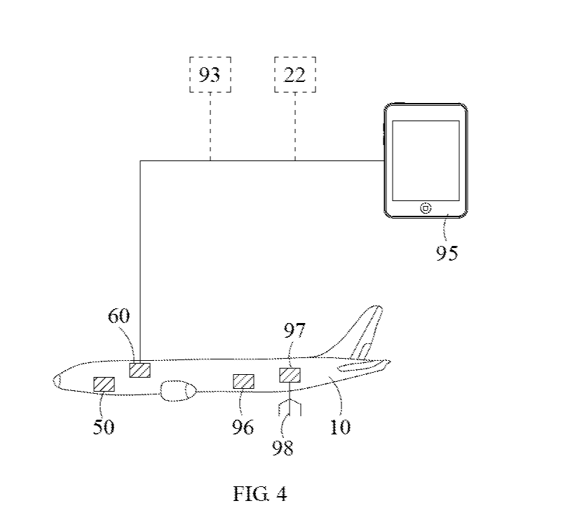

Please refer to FIG. 4 which is a schematic diagram of the third embodiment of an indoor monitoring system according to the present invention. Here, please refer to FIG. 1 and FIG. 4 together. In the present embodiment, the user may send the control instruction 93 through a tablet 95, but it shall not be limited thereto. The control instruction 93 may be sent by the computer, smart phone, and so on. The control instruction 93 is sent to the transmitting unit 60 through the internet, and the processing unit 50 drives the aircraft body 10 to perform monitoring in a specific time or place, or controls the aircraft body 10 simultaneously according to the control instruction 93. On the other hand, the transmitting unit 60 may also instantly transmit each of the captured images 22 or continuous video files to the tablet 95, such that the user is able to obtain the desired contents simultaneously.

In addition, the indoor monitoring system 100 according to the present invention may further includes a driving unit 97 and a robotic manipulator 98 while instant manipulation. The driving unit 97 is disposed on the aircraft body 10 and electrically connected to the robotic manipulator 98 and the processing unit 50 controls the driving unit to drive the robotic manipulator 98 to perform simple motion, such as attraction, grasp, and so on according to the control instruction 93.

Furthermore, the aircraft body 10 disclosed in the indoor monitoring system 100 according to the present invention may further includes a smoke detector, a CO₂ detector, a light source detector, a motion detector, or a combination thereof. The objective of those detectors aims to detect the specific environments such as the fire scene or the hazardous area where people are unable to enter.

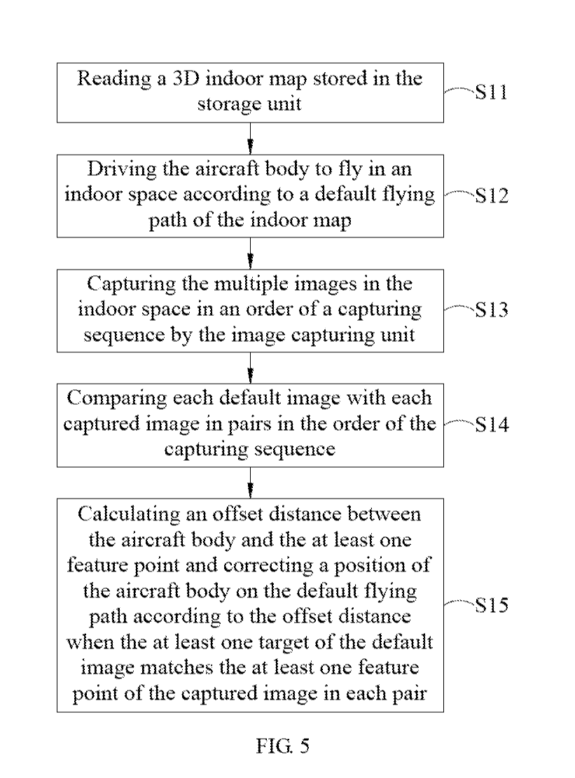

Please refer to FIG. 5 which is a flow chart of an embodiment of an indoor monitoring method according to the present invention. The disclosed indoor monitoring method is applicable to control a micro aircraft in an indoor space. The micro aircraft includes an aircraft body, an image capturing unit, a storage unit, a positioning unit, a processing unit, a transmitting unit and a power supply unit. The indoor monitoring method includes the following steps.

Step S11: reading a 3D indoor map stored in the storage unit. As shown in FIG. 1, the 3D indoor map 31 includes multiple default images 32 and each default image 32 includes at least one target 33.

Step S12: driving the aircraft body to fly in the indoor space according to a default flying path of the indoor map;

Step S13: capturing multiple images in the indoor space in an order of a capturing sequence by the image capturing unit. As shown in FIG. 1, each captured image 22 includes at least one feature point 23.

Step S14: comparing each default image with each captured image in pairs in the order of the capturing sequence; and

Step S15: calculating an offset distance between the aircraft body and the at least one feature point and correcting a position of the aircraft body on the default flying path according to the offset distance when the at least one target of the default image matches the at least one feature point of the captured image in each pair. The processing unit applies the 3D space information generated by the positioning unit to further correct the position of the aircraft body on the default flying path. The positioning unit may include a triaxial accelerometer, a gyroscope, an electronic compass, or a combination thereof. The correction method of the aircraft body has been described in FIG. 1, and the unnecessary details are omitted here.

Besides, in the Step S15, the processing unit transmits the captured image to the cloud server by the transmitting unit and the cloud server performs the image recognition to the captured image to monitor whether any unusual situation occurs when at least one target of the default image does not match at least one feature point of the captured image in each pair.

Preferably, the present method may further include placing the wireless charging unit on a landing pad, and the wireless charging unit may charge the power supply unit when the aircraft body lands on the landing pad.

Preferably, the present method may further include applying the transmitting unit to receive the control instruction, and the aircraft body may be driven to perform flying and monitoring in a specific time or place according to the control instruction.

Preferably, the present method may further include applying the transmitting unit to instantly transmit each captured image to a mobile device, and the user may be able to see the captured image instantly through the mobile device. The aircraft body may further include a smoke detector, a CO₂ detector, a light source detector, a motion detector, or a combination thereof to perform monitoring for a specific purpose, such as monitoring the fire scene.

As mentioned above, an indoor monitoring system and a method thereof disclosed in the present in invention are able to resolve the shortcomings of the blind spot which the conventional indoor monitoring systems are unable to solve. In addition, applying a micro aircraft to perform monitoring an indoor space is also able to effectively avoid the micro aircraft body being damaged as accidental collision in the indoor space.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. An indoor monitoring method which is applicable to control a micro aircraft in an indoor space, the micro aircraft comprising: an aircraft body, an image capturing unit, a storage unit, a positioning unit, a processing unit, a transmitting unit and a power supply unit, and the method comprising:
reading a 3D indoor map stored in the storage unit, wherein the 3D indoor map comprises multiple default images and each default image comprises at least one target;
driving the aircraft body to fly in the indoor space according to a default flying path of the indoor map;
capturing multiple images in the indoor space in an order of a capturing sequence by the image capturing unit, wherein each captured image comprises at least one feature point;
comparing each default image with each captured image in pairs in the order of the capturing sequence; and
calculating an offset distance between the aircraft body and the at least one feature point and correcting a position of the aircraft body on the default flying path according to the offset distance when the at least one target of the default image matches the at least one feature point of the captured image in each pair,
wherein the processing unit applies 3D space information generated by the positioning unit to further correct the position of the aircraft body on the default flying path.

2. The indoor monitoring method of claim 1, further comprising transmitting the captured image to a cloud server by the transmitting unit and performing image recognition to the captured image by the cloud server when the at least one target of the default image does not match the at least one feature point of the captured image in each pair.

3. The indoor monitoring method of claim 1, further comprising disposing a wireless charging unit in a landing pad, and the wireless charging unit charging the power supply unit when the aircraft body lands on the landing pad.

4. The indoor monitoring method of claim 1, further comprising receiving a control instruction by the transmitting unit and driving the aircraft body according to the control instruction by the processing unit.

5. The indoor monitoring method of claim 4, further comprising driving the aircraft body to perform monitoring in a specific time or place according to the control instruction.

6. The indoor monitoring method of claim 1, wherein the positioning unit comprises a triaxial accelerometer, a gyroscope, an electronic compass, or a combination thereof.

7. The indoor monitoring method of claim 1, further comprising instantly transmitting each captured image to a mobile device by the transmitting unit.

8. The indoor monitoring method of claim 1, wherein the aircraft body further comprises a smoke detector, a CO₂ detector, a light source detector, a motion detector, or a combination thereof.

9. An indoor monitoring system, comprising:
an aircraft body;
an image capturing unit, capturing multiple images in an indoor space in an order of a capturing sequence, wherein each captured image comprises at least one feature point;
a storage unit, storing a 3D indoor map corresponding to the indoor space, wherein the 3D indoor map comprises multiple default images and a default flying path, and each default image comprises at least one target;
a positioning unit, generating 3D space information of the aircraft body;
a transmitting unit, receiving a control instruction or transmitting each captured image;
a processing unit, electrically connected to the aircraft body, the image capturing unit, the storage unit, the positioning unit and the transmitting unit, the processing unit driving the aircraft body to fly in the indoor space according to the default flying path and comparing each default image with each captured image in pairs in the order of the capturing sequence, and it calculating an offset distance between the aircraft body and the at least one feature point and correcting a position of the aircraft body on the default flying path according to the offset distance when the at least one target of the default image matches the at least one feature point of the captured image in each pair,
wherein the processing unit applies 3D space information generated by the positioning unit to further correct the position of the aircraft body on the default flying path.

10. The indoor monitoring system of claim 9, wherein the transmitting unit transmits the captured image to a cloud server and the cloud server performs image recognition to the captured image when the at least one target of the default image does not match the at least one feature point of the captured image in each pair.

11. The indoor monitoring system of claim 9, wherein the image capturing unit, the storage unit, the positioning unit, the transmitting unit and the processing unit are disposed on the aircraft body.

12. The indoor monitoring system of claim 9, further comprising a power supply unit and a wireless charging unit, wherein the power supply unit is disposed on the aircraft body for supplying power thereto, and the wireless charging unit is disposed on a landing pad for charging the power supply unit when the aircraft body lands on the landing pad.

13. The indoor monitoring system of claim 9, wherein the processing unit drives the aircraft body to perform monitoring in a specific time or place according to the control instruction.

14. The indoor monitoring system of claim 13, further comprising a driving unit and a robotic manipulator, wherein the driving unit is disposed on the aircraft body and electrically connected to the robotic manipulator and the processing unit controls the driving unit to drive the robotic manipulator to move according to the control instruction.

15. The indoor monitoring system of claim 9, wherein the positioning unit comprises a triaxial accelerometer, a gyroscope, an electronic compass, or a combination thereof.

16. The indoor monitoring system of claim 9, wherein the transmitting unit instantly transmits each captured image to a mobile device.

17. The indoor monitoring system of claim 9, wherein the aircraft body further comprises a smoke detector, a CO₂ detector, a light source detector, a motion detector, or a combination thereof.
